(19) United States
(12) Patent Application Publication
(10) Pub. No.: US 2013/0154420 A1
(43) Pub. Date: Jun. 20, 2013

(54) SPINDLE MOTOR

(71) Applicants: SAMSUNG ELECTRO-MECHANICS CO., LTD., Suwon (KR); IUCF-HYU (Industry-University Cooperation Foundation Hanyang University), Seoul (KR)

(72) Inventors: Han Byul KIM, Suwon (KR); Gun Hee JANG, Seoul (KR); Kyung Mun JUNG, Gwacheon (KR); Ju Ho KIM, Suwon (KR); Hong Joo LEE, Suwon (KR)

(73) Assignees: IUCF-HYU (Industry-University Cooperation Foundation Hanyang University), Seoul (KR); SAMSUNG ELECTRO-MECHANICS CO., LTD., Suwon (KR)

(21) Appl. No.: 13/713,315

(22) Filed: Dec. 13, 2012

(30) Foreign Application Priority Data
Dec. 16, 2011 (KR) 10-2011-0136372

(51) Int. Cl. H02K 5/16

(52) U.S. Cl. CPC H02K 5/16
USPC 310/90

(57) ABSTRACT

There is provided a spindle motor, including: a hub rotating together with a shaft; a sleeve supporting rotation of the shaft via oil; and a pumping part formed in at least one of the sleeve and the hub to pump the oil leaked outside of an interface of the oil in a normal state in a direction toward the interface of the oil in the normal state, wherein a portion of the pumping part may contact the oil in the normal state and the remainder of the pumping part does not contact the oil in the normal state.

### CROSS-REFERENCE TO RELATED APPLICATIONS

This application claims the priority of Korean Patent Application No. 10-2011-0136372 filed on Dec. 16, 2011, in the Korean Intellectual Property Office, the disclosure of which is incorporated herein by reference.

### BACKGROUND OF THE INVENTION

1. Field of the Invention

The present invention relates to a spindle motor, and more particularly, to a spindle motor that may be applied to a hard disk drive (HDD) for rotating a recording disk.

2. Description of the Related Art

A hard disk drive (HDD), an information storage device, is a device that reads data stored on a disk or writes data to a disk, using a read/write head.

The hard disk drive requires a disk driving apparatus capable of driving a disk and as the disk driving apparatus, a spindle motor is commonly used.

The spindle motor uses a fluid dynamic bearing assembly which supports a shaft with fluid pressure generated in oil interposed between the shaft a rotating member of the fluid dynamic bearing assembly, and a sleeve, a fixed member thereof.

Meanwhile, the spindle motor according to the related art includes a pumping groove for preventing oil from being leaked, wherein the pumping groove continuously pumps the oil into a space between the shaft and the sleeve during driving of the spindle motor.

Here, the oil has force applied thereto in a direction towards a space between the shaft and the sleeve due to a pumping force through the pumping groove while simultaneously having force applied thereto in a direction opposite thereto due to centrifugal force according to rotation of the rotating member.

Therefore, the oil has force applied thereto in a specific direction as a result of interaction between the pumping force and the centrifugal force and this resultant force may be changed in magnitude according to the position of the pumping groove.

Therefore, the oil may be separated in the specific area, such that bubbles, and the like, may be generated therein, thereby degrading the performance of the spindle motor.

Further, some oil may be leaked to the outside due to the separation phenomenon of oil, such that a storage quantity of oil for driving the spindle motor may be reduced, thereby increasing power consumption due to solid friction, and the like.

Therefore, research into significantly increasing performance and lifespan of the spindle motor by preventing the separation phenomenon and leakage of oil has been urgently required.

Patent Document 1, provided as the following related art, still has a limitation in that oil may be separated due to a pumping groove and centrifugal force.

### RELATED ART DOCUMENT

(Patent Document 1) Korean Patent Laid-Open Publication No. 2011-0051170

### SUMMARY OF THE INVENTION

An aspect of the present invention provides a spindle motor having improved performance and lifespan by preventing oil provided to implement a fluid dynamic bearing assembly from being leaked and preventing a separation phenomenon of oil.

According to an aspect of the present invention, there is provided a spindle motor, including: a hub rotating together with a shaft; a sleeve supporting rotation of the shaft via oil; and a pumping part formed in at least one of the sleeve and the hub to pump the oil leaked outside of an interface of the oil in a normal state in a direction toward the interface of the oil in the normal state, wherein a portion of the pumping part may contact the oil in the normal state and the remainder of the pumping part does not contact the oil in the normal state.

According to another aspect of the present invention, there is provided a spindle motor, including: a hub rotating together with a shaft; a sleeve supporting rotation of the shaft via oil; and a pumping part formed in at least one of the sleeve and the hub to pump the oil leaked outside of an interface of the oil in a normal state in a direction toward the interface of the oil in the normal state, wherein the pumping part does not contact the oil in the normal state.

The portion of the pumping part that contacts the oil in the normal state may be formed to be smaller than the remainder of the pumping part that does not contact the oil.

The interface of the oil in the normal state may be formed between an upper surface of the sleeve and the hub, and the pumping part may be formed in at least one of the upper surface of the sleeve and an outer circumferential surface thereof adjacent thereto and surfaces of the hub facing the upper surface and the outer circumferential surface of the sleeve.

The hub may be provided with a wall part protruded downwardly in an axial direction such that the interface of the oil in the normal state is formed between the hub and an outer circumferential surface of the sleeve, and the pumping part may be formed in at least one of the outer circumferential surface of the sleeve and the wall part corresponding to the outer circumferential surface of the sleeve.

When the shaft and the hub rotates, the pumping part may prevent the oil provided between an upper surface of the sleeve and the hub from separating in an inner diameter direction and in an outer diameter direction.

When the oil is leaked outside the interface of the oil in the normal state, a portion of the pumping part may contact the oil and the remainder of the pumping part may not contact the oil.

The pumping part may have a spiral shaped pattern.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view illustrating a spindle motor according to an embodiment of the present invention;

FIG. 2 is a schematic cut-away perspective view illustrating a hub provided in the spindle motor according to the embodiment of the present invention;

FIGS. 3 and 4 are schematic cross-sectional views (illustrating only a portion corresponding to portion A of FIG. 1) illustrating a separation phenomenon of oil and a leakage phenomenon of oil due to a pumping part in a general spindle motor;

FIG. 5 is a schematic enlarged cross-sectional view of portion A of FIG. 1, for describing a function of a pumping part provided in the spindle motor according to the embodiment of the present invention;

FIG. 6 is a schematic enlarged cross-sectional view illustrating another example of portion A of FIG. 1;

FIG. 7 is a schematic cross-sectional view illustrating a spindle motor according to another embodiment of the present invention;

FIG. 8 is a schematic enlarged cross-sectional view of portion B of FIG. 7, for describing a function of a pumping part provided in the spindle motor according to another embodiment of the present invention; and

FIG. 9 is a schematic enlarged cross-sectional view illustrating another example of portion B of FIG. 7.

### DETAILED DESCRIPTION OF THE INVENTION

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

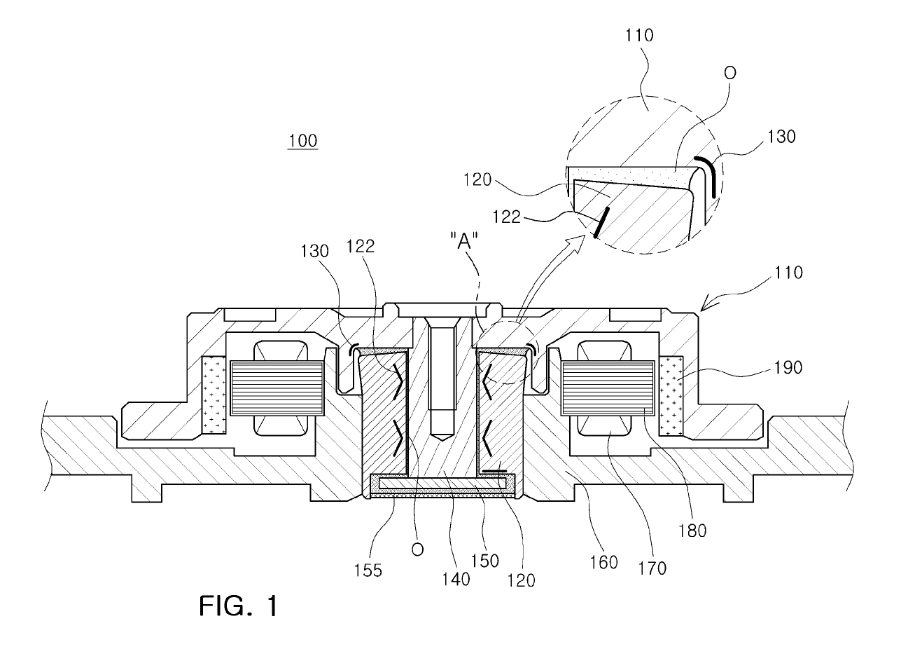

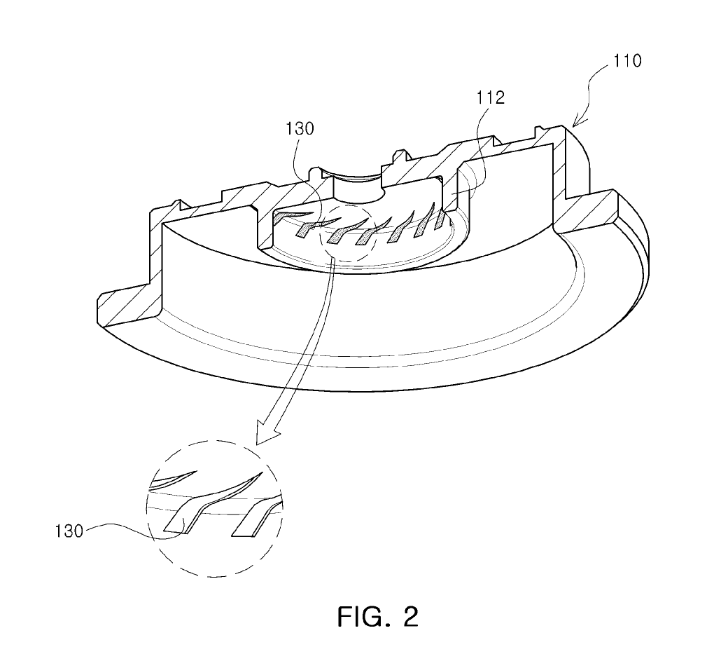

FIG. 1 is a schematic cross-sectional view illustrating a spindle motor according to an embodiment of the present invention and FIG. 2 is a schematic cut-away perspective view illustrating a hub provided in the spindle motor according to the embodiment of the present invention.

First, terms with respect to directions will be defined. When viewed in FIG. 1, an axial direction may refer to a vertical direction based on a shaft 140, and an outer diameter or inner diameter direction may refer to a direction toward an outer edge of a hub 110 based on the shaft 140 or vice-versa.

In addition, the term “normal state” used herein refers to a state in which a spindle motor 100 according to the embodiment of the present invention is stopped.

Referring to FIGS. 1 to 2, the spindle motor 100 according to the embodiment of the present invention may include the hub 110, a rotating component, and a sleeve 120 and a pumping part 130, fixed components.

The hub 110 may be a rotating structure rotating together with the shaft 140 and rotatably disposed with respect to a fixed member including a base 160.

Here, the hub 110 may include a magnet 190 on an inner circumferential surface thereof, the magnet 190 having an annular ring shape and corresponding to a core 180 around which a coil 170 coupled to the base 160 is wound with a predetermined interval.

The magnet 190 may be a component that provides a rotational driving force of the spindle motor 100 according to the embodiment of the present invention, wherein the rotational driving force may be generated by electromagnetic interaction between the magnet 190 and the coil 170 wound around the core 180.

The shaft 140 is a rotating component that is coupled to the hub to rotate together therewith and may be supported by the sleeve 120.

Here, the sleeve 120 is a component that supports rotation of the shaft 140, a rotating component, via oil O and may support the shaft 140 such that an upper portion of the shaft 140 is protruded upwardly in the axial direction. The sleeve 120 may be formed by forging Cu or Al or sintering a Cu—Fe-based alloy powder or a SUS-based powder.

The sleeve 120 may provided with a shaft hole into which the shaft 140 is inserted to form a micro-clearance therebetween, and the micro-clearance is filled with oil O such that the sleeve 120 may stably support the shaft 140 by a radial dynamic pressure via the oil O.

In this configuration, the radial dynamic pressure due to the oil O may be generated by a fluid dynamic pressure part 122 that is concavely formed on an inner circumferential surface of the sleeve 120, and the fluid dynamic pressure part 122 may have a herringbone shape, a spiral shape, or a helical (screw)shape.

However, the fluid dynamic pressure part is not necessarily formed on the inner circumferential surface of the sleeve 120 and therefore, it is to be noted that the fluid dynamic pressure part may be formed on an outer circumferential surface of the shaft 140 and the number thereof is not limited.

Meanwhile, a stopper 150 may be coupled to a bottom surface of the shaft 140, and in this case, the stopper 150 may be a component for preventing a rotating member including the shaft 140 from overfloating.

In this configuration, the stopper 150 is separately manufactured and may be coupled with the shaft 140, but may also be integrally formed with the shaft 140 during a manufacturing process and may rotate together with the shaft 140 at the time of the rotation of the shaft 140.

When the rotating member including the shaft 140 overfloats, an outer surface of the stopper 150 may contact the bottom surface of the sleeve 120 to prevent the rotating member from overfloating.

Meanwhile, the sleeve 120 may have a base cover 155 coupled to a lower portion thereof in the axial direction while having a clearance between the sleeve 120 and the base cover 155, the clearance being filled with the oil O.

The clearance between the base cover 155 and the sleeve 122 is filled with the oil O such that the base cover 155 may serve as a bearing supporting a bottom surface of the stopper 150.

Further, the clearance between the shaft 140 and the sleeve 120, a clearance between the hub 110 and the sleeve 120, and a clearance between the base cover 155 and the stopper 150 may be continuously filled with the oil O to form a full-fill structure overall.

Further, a clearance between an upper surface of the sleeve 120 and the hub 110 facing the upper surface of the sleeve 120 may be increased in the outer diameter direction.

In detail, as illustrated in FIG. 1, the upper surface of the sleeve 120 may be inclined downwardly in the outer diameter direction.

Further, although not illustrated, one surface of the hub 110 facing the upper surface of the sleeve 120 may be inclined upwardly in the outer diameter direction and the upper surface of the sleeve 120 and one surface of the hub 110 may also be formed to be simultaneously inclined.

This is to prevent the oil O from being leaked by using a capillary phenomenon of the oil O provided in the clearance between the upper surface of the sleeve 120 and the hub 110 facing the upper surface of the sleeve 120, thereby significantly increasing the sealing capability of the oil O while securing the storage space of the oil O.

In other words, an interface of the oil O may be formed between the upper surface of the sleeve 120 and the hub 110 corresponding to the upper surface of the sleeve 120 and so-called horizontal sealing may be implemented to prevent the oil O from being leaked due to an external impact, or the like.

The pumping part 130 is formed in at least one of the sleeve 120 and the hub 110, such that the oil O leaked outwardly of the interface of the oil O in the normal state may be pumped in a direction toward the interface of the oil O in the normal state.

Here, the interface of the oil O in the normal state may be formed between the sleeve 120 and the hub 110 and the pumping part 130 may be formed in at least one of the upper surface of the sleeve 120 and an outer circumferential surface thereof adjacent thereto and surfaces of the hub 110 facing the upper surface and the outer circumferential surface of the sleeve 120.

In other words, the hub 110 may be provided with a wall part 112 protruded downwardly from the outer diameter direction of the sleeve 120 in the axial direction and the pumping part 130 may be formed to extend from one surface of the hub 110 corresponding to the upper surface of the sleeve 120 to the wall part 112.

Meanwhile, a portion of the pumping part 130 may contact the oil O in the normal state and the remainder thereof may not contact the oil O in the normal state.

Here, a portion of the pumping part 130 that contacts the oil O in the normal state may be formed to be smaller than the remainder of the pumping part 130 that does not contact the oil O.

Therefore, at the time of the driving of the spindle motor 100 according to the embodiment of the present invention, that is, at the time of the rotation of the rotating member including the shaft 140 and the hub 110, the oil O have the pumping force applied thereto, the pumping force being exerted in the inner diameter direction by the pumping part 130.

That is, even in the case in which the oil O has force applied thereto in the outer diameter direction by the centrifugal force according to the rotation of the rotating member, the leakage of the oil O can be prevented by the pumping force generated by the pumping part 130.

In other words, at the time of the driving of the spindle motor 100, according to the embodiment of the present invention, the oil O may deviate from an interface position of the oil O in the normal state due to external impacts, and the like, but the oil O deviating from the interface position of the oil O in the normal state may continuously contact the pumping part 130 and therefore, may have pumping force continuously applied thereto in the inner diameter direction.

Here, a portion of the pumping part 130 may maintain a state of non-contact with the oil O deviating from the interface position of the oil O in the normal state.

Further, at the time of the driving of the spindle motor 100 according to the embodiment of the present invention, the separation phenomenon of the oil O provided between the upper surface of the sleeve 120 and the hub 110 is prevented by the pumping part 130, thereby preemptively preventing the generation of bubbles due to the separation.

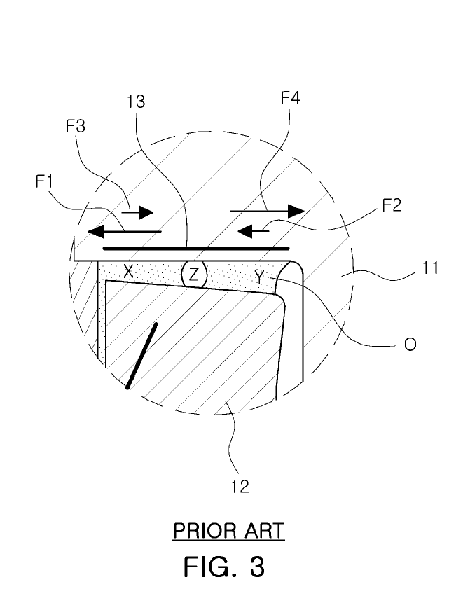

This will be described in detail with reference to FIGS. 3 to 5.

Meanwhile, the pumping part 130 may have a spiral shape that is a semi-herringbone shape as illustrated in FIG. 2, but is not necessarily limited thereto. Therefore, as long as the pumping part 130 may pump the oil O deviating from the interface of the oil O in the normal state in the direction toward the interface of the oil O in the normal state, any shape may be applied thereto.

That is, the pumping part may have a herringbone shape or a helical (screw) shape.

Therefore, the pumping part 130 performs an important function in the spindle motor 100 according to the embodiment of the present invention in which the amount of the oil O and the interface position of the oil O are important. In other words, the pumping part 130 prevents the oil O from being leaked due to an external impact or a rise in temperature, thereby significantly reducing noise, vibrations, and non-repeatable runout (NRRO) that occur due to the leakage of the oil O.

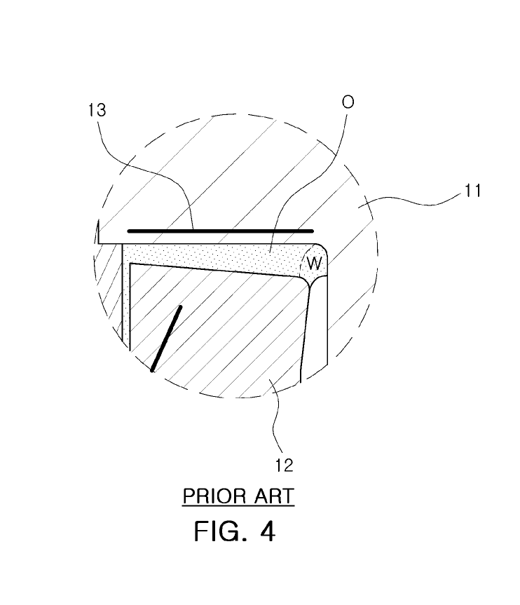

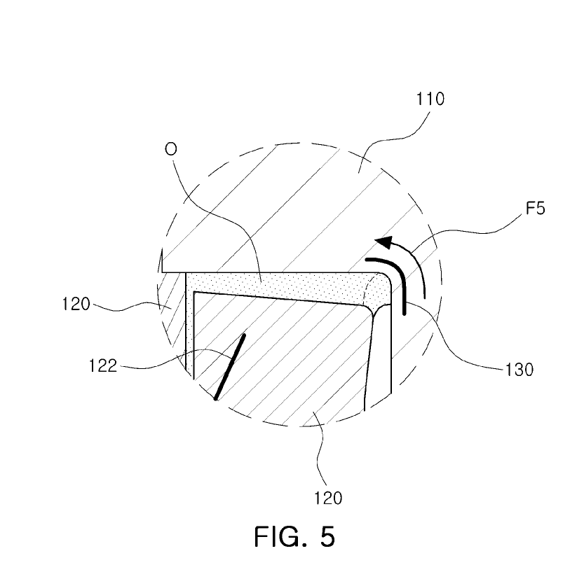

FIGS. 3 and 4 are schematic cross-sectional views (illustrating only a portion corresponding to portion A of FIG. 1) illustrating a separation phenomenon of oil and a leakage phenomenon of oil due to a pumping part in a general spindle motor. FIG. 5 is a schematic enlarged cross-sectional view of portion A of FIG. 1, for describing a function of a pumping part provided in the spindle motor according to the embodiment of the present invention.

Referring first to FIG. 3, in the general spindle motor, the pumping part 13 is formed on one surface of the hub 11 corresponding to the upper surface of the sleeve 12 and the oil O has pumping forces F1 and F2 applied thereto in the inner diameter direction by the pumping part 13.

In other words, at the time of the driving of the spindle motor, the oil O simultaneously has the pumping forces F1 and F2 applied thereto by the pumping part 13 and centrifugal forces F3 and F4 according to the rotation of the rotating member, and the pumping forces F1 and F2 and the centrifugal forces F3 and F4 may be varied according to a position of the pumping part 13.

That is, the pumping forces F1 and F2 caused by the pumping part 13 are in inverse proportion to a size of the clearance between the sleeve 12 and the hub 11 and therefore, are increased in the inner diameter direction and the centrifugal forces F3 and F4 are in proportion to a size of a rotation radius and therefore, are increased in the outer diameter direction.

Therefore, the oil O provided in portion X has force applied thereto in the inner diameter direction due to the pumping force F1 larger than the centrifugal force F3, while the oil O provided in portion Y has force applied thereto in the outer diameter direction due to the centrifugal force F4 larger than the pumping force F2.

Therefore, negative force is generated in the oil O provided in portion Z between the sleeve 12 and the hub 11, such that bubbles may occur.

Here, the bubbles may be introduced into the fluid dynamic pressure part, and the like, such that a normal dynamic pressure is not generated, thereby causing vibrations and noise.

Further, referring to FIG. 4, in the general spindle motor, the oil O may deviate from the interface position of the oil O in the normal state due to external impacts or a rise in temperature. In this case, the oil O is positioned outside of the pumping part 13, such that the pumping force is not applied to the oil O in portion W.

Therefore, the oil O in portion W is highly likely to be leaked to the outside, such that power consumption may be increased due to solid friction, and the like, caused by the leakage of the oil O.

Further, rigidity of the bearing may be degraded due to a lack of the oil O, such that the performance and lifespan of the spindle motor may be degraded.

However, referring to FIG. 5, at the time of the driving of the spindle motor 100 according to the embodiment of the present invention, the oil O may deviate from the interface position of the oil O in the normal state due to external impacts, and the like. However, the oil O deviating from the interface position of the oil O in the normal state may continuously contact the pumping part 130 and therefore, continuously has a pumping force F5 applied thereto in the inner diameter direction.

Here, a portion of the pumping part 130 may still maintain a state of non-contact with the oil O deviating from the interface position of the oil O in the normal state.

Therefore, the spindle motor 100 according to the embodiment of the present invention may prevent the separation phenomenon of the oil O and the leakage of the oil O due to the pumping force and the centrifugal force, thereby significantly increasing the performance and the lifespan of the motor.

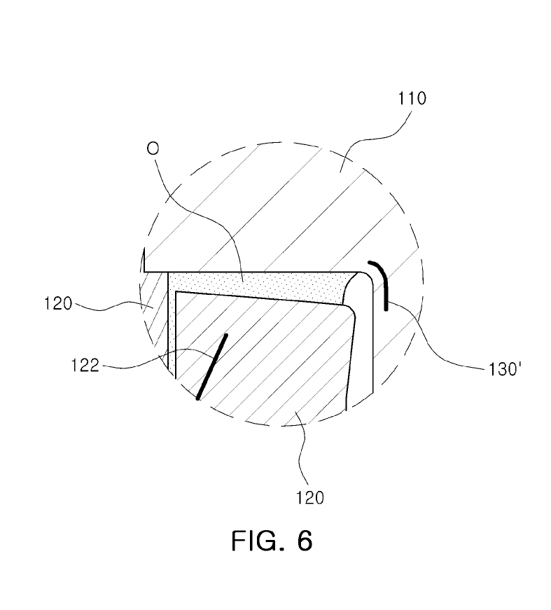

FIG. 6 is a schematic enlarged cross-sectional view illustrating another example of portion A of FIG. 1.

Referring to FIG. 6, a pumping part 130′ may be formed outside the interface of the oil O in the normal state to maintain the state of non-contact with the oil O.

However, when the oil O deviates from the interface position of the oil O in the normal state due to external impacts, and the like, the pumping part 130′ may contact the oil O deviating from the interface position of the oil O in the normal state to provide the pumping force in the inner diameter direction.

Therefore, the leakage of the oil O may be prevented.

Other configurations and effects may be the same as those in the foregoing embodiments.

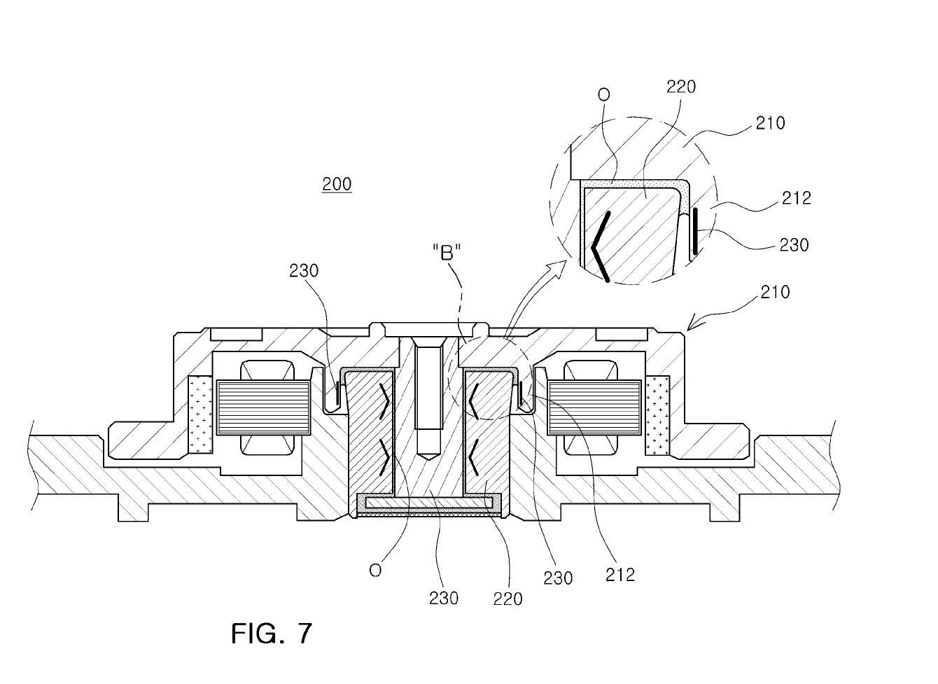

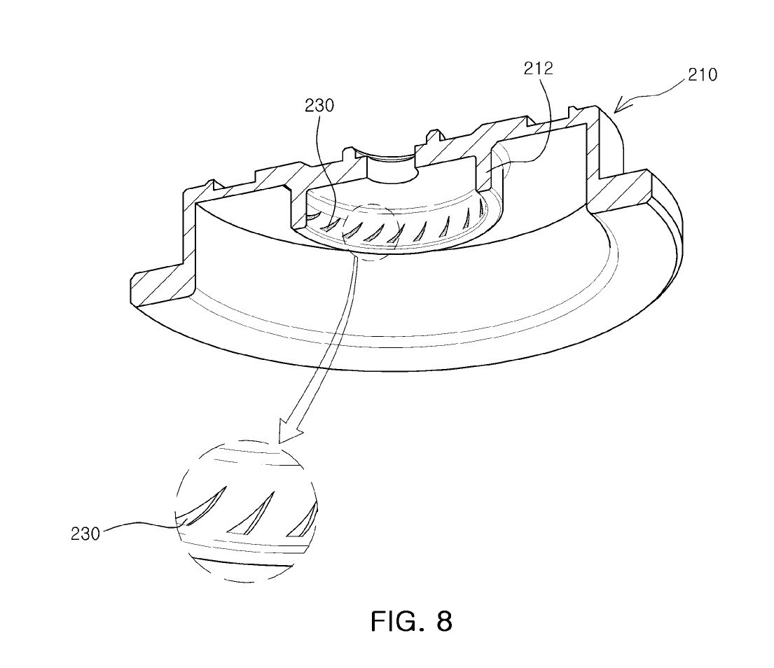

FIG. 7 is a schematic cross-sectional view illustrating a spindle motor according to another embodiment of the present invention and FIG. 8 is a schematic enlarged cross-sectional view of portion B of FIG. 7, for describing a function of a pumping part provided in the spindle motor according to another embodiment of the present invention.

Referring to FIGS. 7 and 8, a spindle motor 200 according to another embodiment of the present invention is the same as the spindle motor 100 according to the embodiment of the present invention described with reference to FIGS. 1 and 2 except for the interface position of the oil O in the normal state and the formation position of a pumping part 230 and therefore, descriptions other than the interface position of the oil O in the normal state and the formation position of the pumping part 230 will be omitted.

The interface of the oil O in the normal state may be formed between an outer circumferential surface of a sleeve 220 and a wall part 212 of a hub 210.

Here, the pumping part 230 may be formed in at least one of the sleeve 220 and the hub 210, in detail, may be formed on at least one of the outer circumferential surface of the sleeve 220 and a portion of the wall part 212 corresponding to the outer circumferential surface of the sleeve 220.

Meanwhile, a portion of the pumping part 230 may contact the oil O in the normal state and the remainder thereof may not contact the oil O in the normal state.

Here, the portion of the pumping part 230 that contacts the oil O in the normal state may be formed to be smaller than the remainder of the pumping part 230 that does not contact the oil O.

Therefore, at the time of the driving of the spindle motor 200 according to the embodiment of the present invention, that is, at the time of the rotation of the rotating member including a shaft 240 and the hub 210, the oil O may have the pumping force applied thereto, the pumping force directing toward a clearance between the shaft 240 and the sleeve 220 by the pumping part 230.

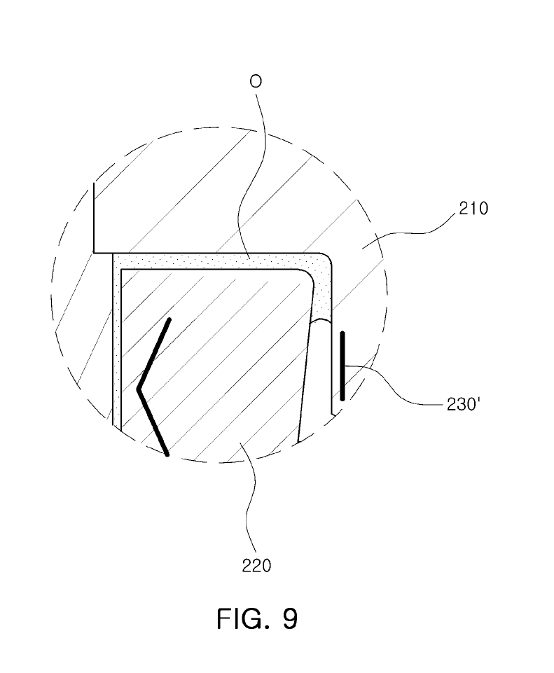

FIG. 9 is a schematic enlarged cross-sectional view illustrating another example of portion B of FIG. 7.

Referring to FIG. 9, a pumping part 230′ may be formed outside the interface of the oil O in the normal state to maintain the state of non-contact with the oil O.

However, when the oil O deviates from the interface position of the oil O in the normal state due to external impacts, and the like, the pumping part 130′ may contact the oil O deviating from the interface position of the oil O in the normal state to provide the pumping force directing toward the clearance between the shaft 240 and the sleeve 220.

As set forth above, according to the spindle motor of the embodiments of the present invention, the separation phenomenon of oil can be prevented, thereby preventing oil from being leaked.

Further, according to the embodiments of the present invention, the leakage of oil can be prevented to secure the storage quantity of oil and reduce power consumption, thereby significantly increasing the performance and lifespan of the spindle motor.

While the present invention has been shown and described in connection with the embodiments, it will be apparent to those skilled in the art that modifications and variations can be made without departing from the spirit and scope of the invention as defined by the appended claims.

What is claimed is:

1. A spindle motor, comprising:
a hub rotating together with a shaft;
a sleeve supporting rotation of the shaft via oil; and
a pumping part formed in at least one of the sleeve and the hub to pump the oil leaked outside of an interface of the oil in a normal state in a direction toward the interface of the oil in the normal state,
wherein a portion of the pumping part contacts the oil in the normal state and the remainder of the pumping part does not contact the oil in the normal state.

2. A spindle motor, comprising:
a hub rotating together with a shaft;
a sleeve supporting rotation of the shaft via oil; and
a pumping part formed in at least one of the sleeve and the hub to pump the oil leaked outside of an interface of the oil in a normal state in a direction toward the interface of the oil in the normal state,
wherein the pumping part does not contact the oil in the normal state.

3. The spindle motor of claim 1, wherein the portion of the pumping part that contacts the oil in the normal state is formed to be smaller than the remainder of the pumping part that does not contact the oil.

4. The spindle motor of claim 1, wherein the interface of the oil in the normal state is formed between an upper surface of the sleeve and the hub, and
the pumping part is formed in at least one of the upper surface of the sleeve and an outer circumferential surface thereof adjacent thereto and surfaces of the hub facing the upper surface and the outer circumferential surface of the sleeve.

5. The spindle motor of claim 1, wherein the hub is provided with a wall part protruded downwardly in an axial direction such that the interface of the oil in the normal state is formed between the hub and an outer circumferential surface of the sleeve, and
the pumping part is formed in at least one of the outer circumferential surface of the sleeve and the wall part corresponding to the outer circumferential surface of the sleeve.

6. The spindle motor of claim 1, wherein when the shaft and the hub rotates, the pumping part prevents the oil provided between an upper surface of the sleeve and the hub from separating in an inner diameter direction and in an outer diameter direction.

7. The spindle motor of claim 1, wherein when the oil is leaked outside the interface of the oil in the normal state, a portion of the pumping part contacts the oil and the remainder of the pumping part does not contact the oil.

8. The spindle motor of claim 1, wherein the pumping part has a spiral shape.

9. The spindle motor of claim 2, wherein the interface of the oil in the normal state is formed between an upper surface of the sleeve and the hub, and
the pumping part is formed in at least one of the upper surface of the sleeve and an outer circumferential surface thereof adjacent thereto and surfaces of the hub facing the upper surface and the outer circumferential surface of the sleeve.

10. The spindle motor of claim 2, wherein the hub is provided with a wall part protruded downwardly in an axial direction such that the interface of the oil in the normal state is formed between the hub and an outer circumferential surface of the sleeve, and
the pumping part is formed in at least one of the outer circumferential surface of the sleeve and the wall part corresponding to the outer circumferential surface of the sleeve.

11. The spindle motor of claim 2, wherein when the shaft and the hub rotates, the pumping part prevents the oil provided between an upper surface of the sleeve and the hub from separating in an inner diameter direction and in an outer diameter direction.

12. The spindle motor of claim 2, wherein when the oil is leaked outside the interface of the oil in the normal state, a portion of the pumping part contacts the oil and the remainder of the pumping part does not contact the oil.

13. The spindle motor of claim 2, wherein the pumping part has a spiral shape.
